(19) United States
(12) Patent Application Publication
(10) Pub. No.: US 2026/0267960 A1
(43) Pub. Date: Sep. 10, 2026

(54) OPERATING SYSTEM KERNEL INTEGRITY INSPECTION IN A TRUSTED EXECUTION ENVIRONMENT

(71) Applicant: Hewlett Packard Enterprise Development LP, Spring, TX (US)

(72) Inventors: Geoffrey Ndu, Bristol (GB); Nigel John Edwards, Bristol (GB); Theofrastos Koulouris, Bristol (GB)

(21) Appl. No.: 19/074,556

(22) Filed: Mar. 10, 2025

(51) Int. Cl. G06F 21/53; G06F 9/455

(52) U.S. Cl. CPC G06F 21/53; G06F 9/45558; G06F 2009/45587; G06F 2221/033

(57) ABSTRACT

A processing resource may execute a first confidential virtual machine (CVM) in a trusted execution environment (TEE) at a first privilege level. The first CVM may include a guest operating system (OS) kernel stored in a private memory, which is inaccessible via direct memory access. The processing resource may execute a second CVM in the TEE at a different, second privilege level. Based on the second privilege level, the private memory is accessible to the second CVM. An integrity scanning application of the second CVM may access the private memory to determine a current measurement of the guest OS kernel and may determine whether the guest OS kernel is compromised based on a comparison of the current measurement and an initial measurement of the guest OS kernel.

### BACKGROUND

An electronic device can include an operating system (OS) that manages resources of the electronic device. The resources include hardware resources, program resources, and other resources. The OS includes a kernel, which is the core of the OS and performs various tasks, including controlling hardware resources, arbitrating conflicts between processes relating to the resources, managing file systems, performing various services for parts of the electronic device, including other parts of the OS, and so forth.

### BRIEF DESCRIPTION OF THE DRAWINGS

Some implementations of the present disclosure are described with respect to the following figures.

FIG. 1 is a block diagram of an example arrangement that includes an electronic device in which a first confidential virtual machine (CVM) and a second CVM can execute within a trusted execution environment, according to some examples;

FIG. 2 is a flow diagram of a process for OS kernel integrity inspection involving an inspection signal, according to some examples;

FIG. 3 is a flow diagram of a process for OS kernel integrity inspection involving an interrupt, according to some examples;

FIG. 4 is a flow diagram of a process for performing OS kernel integrity inspection using a first CVM and a second CVM executed in a TEE, according to some examples;

FIG. 5 is a block diagram of a machine-readable storage medium having instructions for performing OS kernel integrity inspection using a first CVM and a second CVM executed in a TEE, according to some examples; and

FIG. 6 is a block diagram of an electronic device capable of performing OS kernel integrity inspection using a first CVM and a second CVM executed in a TEE, according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Malware can compromise a kernel of an operating system (OS) by inserting malicious code into or otherwise modifying the kernel. Alternatively, the OS kernel may be compromised when errors are introduced into the kernel, such as due to malfunction of hardware or machine-readable instructions. To protect the integrity of the OS kernel, the OS kernel may be inspected for changes that may be indicative of compromise using, for example, software designed for this purpose.

Executing OS kernel integrity inspection software in the same space as the OS kernel may expose the software to the same risks posed by malicious code targeting the OS kernel. Accordingly, in some electronic devices, a peripheral device (e.g., a peripheral component interconnect express (PCIe) device) using direct memory access (DMA) or a hypervisor may access unencrypted host system memory to monitor the integrity of an OS kernel. By using a peripheral device or a hypervisor, OS kernel integrity inspection may be performed in a space separate from where the OS kernel is executed, which may reduce the risk that the software for the OS kernel integrity inspection will be compromised by the same malicious code that threatens the OS kernel.

Confidential computing protects data and code during processing by using hardware-based, attested trusted execution environments (TEE). In environments employing confidential computing, OS kernel integrity inspection using DMA or by a hypervisor may not be available, as host system memory may be encrypted and/or private. A virtual machine running in a TEE (referred to herein as a “confidential virtual machine (CVM)”) may include shared memory and private memory, for example, and may store its OS kernel (e.g., a guest OS kernel) in private memory. While data in shared memory may be shared with the host, such as to a DMA buffer, TEEs make private memory inaccessible to entities executing outside the TEE, such as a peripheral device using DMA or a hypervisor. Accordingly, OS kernel integrity inspection involving DMA and/or hypervisor access to the guest OS kernel of a CVM may be unavailable.

To address these issues, examples described herein relate to OS kernel integrity inspection distributed between two CVMs executed within the same TEE and having different privilege levels. In particular, a first, less privileged, CVM executed in a TEE may include a guest OS kernel stored in a private memory (e.g., one or more private pages). Because the memory is private and the CVM is executed in a TEE, the guest OS kernel may be inaccessible via direct memory access. A second, more privileged, CVM executed in the TEE may enable its own access to the private memory. For instance, the second CVM may configure guest memory, including private memory, for less privileged CVMs in the TEE. An integrity scanning application of the second CVM may thus access and measure critical regions of the guest OS kernel. The integrity scanning application may determine whether the guest OS kernel is compromised by comparing its current measurement of the guest OS kernel to an initial measurement, which may be determined at the first CVM. Accordingly, OS kernel integrity inspection may be performed in a TEE without DMA or use of a hypervisor.

As described herein, the term “OS kernel integrity inspection” may relate to operations to determine whether an OS kernel has been compromised, such as due to insertion of malware into the OS kernel by an attacker or due to any other type of corruption of the OS kernel. For instance, OS kernel integrity inspection may involve a determination and comparison of measurements of the OS kernel to determine whether the OS kernel has been modified.

Direct memory access (DMA) may relate to access by an input/output (I/O) and/or hardware device, such as a peripheral device or a baseboard management controller (BMC) (e.g., a specialized service processor), to system memory without the intervention of a central processing unit (CPU). A device may use DMA to read from or write to memory.

The term “trusted execution environment (TEE),” which may alternatively be referred to as a protected execution environment (PEE), may relate to an area located in a processor that protects machine-readable instructions and data loaded into the area with respect to confidentially and integrity. A TEE may be established by firmware or software, and a TEE may be a hardware-backed TEE, meaning the TEE uses hardware, such as one or more components of a hardware processor, to protect instructions and data.

In the context of a CVM, the TEE may protect a memory (e.g., a private memory) of the CVM by making the contents (e.g., machine-readable instructions, data, and the like) of the memory inaccessible to entities executing outside the TEE (referred to herein as “external entities”), while keeping the contents accessible to entities executing in the TEE. External entities may include entities executing on the same physical platform as a CVM, other tenants, a hypervisor, a service provider (e.g., a cloud service provider (CSP), other users, applications, processes, services, an input/output (I/O) and/or hardware device, such as a peripheral device or a BMC, or any other entity executing outside the TEE. As described herein, a TEE may make memory “inaccessible” to external entities by preventing external entities from reading from or writing to (e.g., modifying) the memory. A TEE may, for example, make memory “inaccessible” to external entities by encrypting its contents so that external entities are not able to decipher the encrypted contents. Thus, an external entity attempting to read the memory, such as a peripheral device attempting to read the memory using DMA, may read indecipherable encrypted contents (e.g., ciphertext). A TEE may also make memory “inaccessible” to external entities by denying write access for external entities to the memory. On the other hand, the TEE may keep the memory accessible (e.g., accessible to read from and/or write to) to entities executing within the TEE. The TEE may, for example, allow write access and may enable decryption (e.g., by providing a key) of the memory contents for entities executing within the TEE.

In executing both the first CVM and the second CVM in the TEE, a guest memory, which may include a private memory for the first CVM and a private memory for the second CVM, may be accessible to both the first CVM and the second CVM. That is, for example, because the second CVM is executed in the same TEE, the second CVM may access the private memory of the first CVM and vice versa. With access to the private memory of the first CVM, the second CVM may monitor the guest OS kernel stored therein. For instance, the integrity scanning application may measure regions of the guest OS kernel to determine whether they have been modified. Access by the first CVM to the private memory of the second CVM, however, may risk compromise of the integrity scanning application stored therein. With such access, for example, malware targeting the guest OS kernel may further modify the integrity scanning application. Compromise of the integrity scanning application may lead to failed OS kernel integrity inspection of the guest OS kernel and/or undetected corruption of the guest OS kernel. In this regard, the ability of the integrity scanning application to measure the guest OS kernel and/or to communicate a status of the guest OS kernel may be hindered.

To reduce the risk that compromise of the guest OS kernel will also compromise the integrity scanning application, the first CVM and second CVM may be executed at different privilege levels. By executing the second CVM at a more privileged level than the first CVM, the second CVM may set the access rights to the guest memory, including access rights for the first CVM to the private memory of the second CVM. The second CVM may thus make the private memory of the second CVM inaccessible to the first CVM, while keeping the private memory of the first CVM accessible to the second CVM. As such, the second CVM may enable monitoring of the guest OS kernel by the integrity scanning application, while creating a separation between the integrity scanning application and the guest OS kernel, preventing access to (e.g., modification of) the integrity scanning application by the first CVM.

Using the techniques described herein, OS kernel integrity inspection may be performed on a guest OS kernel in a TEE. By being able to monitor a guest OS kernel using mechanisms described herein, compromised guest OS kernels can be detected. Moreover, remedial actions can be taken with respect to a compromised guest OS kernel, which may prevent unauthorized access, loss of data, or other errors in an electronic device. Further, by executing the first and second CVMs at different privilege levels, the risk that compromise of a guest OS kernel goes undetected and/or unreported may be reduced, as the second CVM may be separated from exposure to the same risks posed to the first CVM.

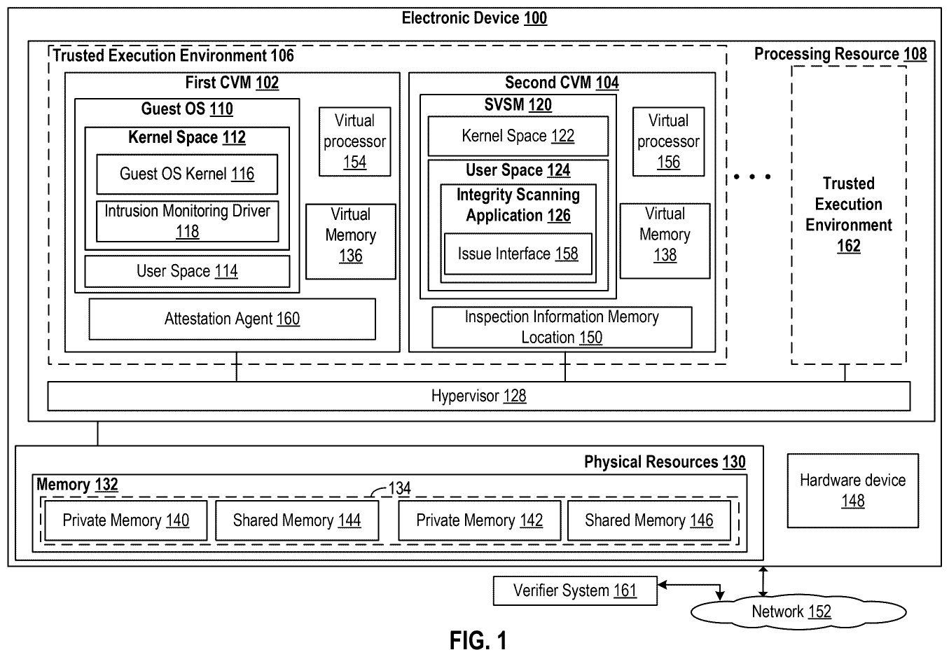

FIG. 1 is a block diagram of an example arrangement that includes an electronic device 100 in which a first CVM 102 and a second CVM 104 can execute within a TEE 106. Examples of the electronic device 100 can include any or some combination of the following: a server computer, desktop computer, a notebook computer, a tablet computer, a smartphone, and so forth.

The first CVM 102 and the second CVM 104 can execute on a processing resource 108 of the electronic device 100. The processing resource 108 can include a collection of hardware processors. As used here, a “collection” of items can refer to a single item or multiple items. Thus, a collection of hardware processors can refer to a single hardware processor or multiple hardware processors. A hardware processor can include a microprocessor, a core of a multi-core microprocessor, a microcontroller, a programmable integrated circuit, a programmable gate array, or another hardware processing circuit.

The processing resource 108 may execute the first CVM 102 and the second CVM 104 in the TEE 106. The TEE 106 may be established by firmware or software executed by the processing resource 108 to protect the first CVM 102 and the second CVM 104 with regards to integrity and confidentiality, as described herein. The TEE 106 may, for example, make machine-readable instructions and/or data associated with the first CVM 102 and/or the second CVM 104 inaccessible to external entities. For instance, the TEE 106 may prevent modification of the instructions and/or data. In some examples, the TEE 106 may encrypt the instructions and/or data so that, even if read, the information is indecipherable (e.g., ciphertext) to an external entity.

The first CVM 102 may include a guest OS 110, which may be segregated into a kernel space 112 and a user space 114. The kernel space 112 may include a guest OS kernel 116 and an intrusion monitoring driver 118. The guest OS kernel 116 may include program code (machine-readable instructions); a list of kernel modules that are used by the guest OS kernel 116 to perform various functions, where a kernel module includes machine-readable instructions; read-only data that is used by the guest OS kernel 116, and so forth. Typically, the guest OS kernel 116 will contain a set of memory regions that should remain static during operation of a CVM, where an operation of the CVM can include booting the CVM or a runtime operation of the CVM after the CVM has been booted. Any modification of the guest OS kernel 116 static memory regions can be an indication that the guest OS kernel 116 has been compromised. The guest OS kernel 116 may be compromised by malware or by another cause (e.g., corruption of the CVM or data errors experienced during execution of the guest OS kernel 116).

The second CVM 104 may include a secure virtual machine service module (SVSM) 120, which may similarly be segregated into a kernel space 122 and a user space 124. The user space 124 may include an integrity scanning application 126. As described herein, OS kernel integrity inspection of the guest OS kernel 116 may be performed by the intrusion monitoring driver 118 of the first CVM 102 and the integrity scanning application 126 of the second CVM 104. In particular, the intrusion monitoring driver 118 may take an initial measurement of the guest OS kernel 116, and the integrity scanning application 126 may compare the initial measurement to a current measurement of the guest OS kernel 116 to determine whether the guest OS kernel 116 has been compromised.

A hypervisor 128 (a virtual machine monitor (VMM)) may manage physical resources 130 of the electronic device 100 for use by the first CVM 102 and the second CVM 104. Examples of physical resources 130 can include the processing resource 108, memory 132 (which may include a collection of memory devices), storage resources (including a collection of storage devices), communication resources (e.g., including a collection of network interface controllers), and so forth. The hypervisor 128 can present emulated (e.g., virtualized) instances of the physical resources 130 that can be used by the first CVM 102 and the second CVM 104. In some examples, the first CVM 102 and the second CVM 104 may be treated as a single guest operating on the host electronic device 100, and the hypervisor 128 may present a set of virtual resources (e.g., virtual processing resource(s), virtual memory resource(s)) that are shared between the first CVM 102 and the second CVM 104, for example.

The hypervisor 128 may, for example, present guest memory 134 to the first CVM 102 and the second CVM 104, and the guest memory 134 may be shared by the first CVM 102 and the second CVM 104. Guest memory 134 may refer to a portion of memory 132 designated for the first CVM 102 and the second CVM 104, as well as virtual memory 136 and virtual memory 138. Virtual memory 136 and virtual memory 138 may represent a virtualized instance of the portion of memory 132. Virtual memory 136 and virtual memory 138 may be respectively presented to the first CVM 102 and the second CVM 104 by the hypervisor 128.

Memory 132 may be divided into pages (e.g., fixed-size chunks), which may be shared or private. Data to be shared by the first CVM 102 or the second CVM 104 with an external entity (e.g., a host device), such as written to a DMA buffer, may be stored in a shared page of memory 132. A private page of memory 132, on the other hand, may be protected by the TEE 106, making the private page inaccessible to external entities.

As shown, the guest memory 134 may include private memory 140 and private memory 142, as well as shared memory 144 and shared memory 146. Private memory may refer to one or more private page(s) of memory 132, and shared memory may refer to one or more shared page(s) of memory 132. In some examples, the first CVM 102 may be stored and may execute in private memory 140 and shared memory 144, and the second CVM 104 may be stored and may execute in private memory 142 and shared memory 146.

In executing the first CVM 102 and the second CVM 104 in the TEE 106, the TEE 106 may protect the private memory 140 and the private memory 142 from access by external entities. The TEE 106 may, on the other hand, enable access to the private memory 140 and the private memory 142 for entities executing within the TEE 106, such as the first CVM 102 and the second CVM 104. In protecting the private memory 140 and the private memory 142, the TEE 106 may prevent content (e.g., machine-readable instructions, data, or the like) in the private memory 140 or the private memory 142 from being modified (e.g., written to) by external entities. The TEE 106 may, for example, deny write access for external entities to the private memory 140 and the private memory 142. Further, in some examples, the TEE 106 may protect the content from being read by external entities. The TEE 106 may, for example, encrypt the content of private memory 140 and private memory 142 so that the content is indecipherable (e.g., ciphertext) if read by external entities.

To illustrate, the electronic device 100 may include a hardware device 148 that is separate from the processing resource 108. The hardware device 148 may be, for example a BMC, a peripheral device, an input/output device, or any other hardware device. A BMC may be a specialized service processor and/or microcontroller that interfaces between hardware of the electronic device 100 and system management software, and may communicate monitored data of the electronic device 100. In some devices, the hardware device 148 may access memory 132 using DMA. However, because the hardware device 148 is separate from the processing resource 108 and is thus executed external to the TEE 106, the TEE 106 may make the private memory 140 and the private memory 142 inaccessible to the hardware device 148 via DMA. As shown, the hypervisor 128 may also be executed outside the TEE 106. Accordingly, the TEE 106 may further make the private memory 140 and the private memory 142 inaccessible to the hypervisor 128.

In some examples, the kernel space 112 of the first CVM 102 may be stored in the private memory 140, and the integrity scanning application 126 may be stored in the private memory 142. With the protection of the TEE 106, the kernel space 112—including the guest OS kernel 116 and the intrusion monitoring driver 118 stored therein—as well as the integrity scanning application 126, may thus be inaccessible to external entities. Yet, the private memory 140 and the private memory 142 may remain accessible to the first CVM 102 and the second CVM 104, as the first CVM 102 and the second CVM 104 are executed within the TEE 106.

As described in greater detail herein, the intrusion monitoring driver 118 of the first CVM 102 may be used in OS kernel integrity inspection of the guest OS kernel 116. The intrusion monitoring driver 118 may access the guest OS kernel 116, as the intrusion monitoring driver 118 may execute within the TEE 106, and the intrusion monitoring driver 118 may measure the guest OS kernel 116. At the same time, because the intrusion monitoring driver 118 is in the kernel space 112, the intrusion monitoring driver 118 may be vulnerable to the same risks as the guest OS kernel 116. Corruption of the intrusion monitoring driver 118 may thus lead to failed integrity inspection of the guest OS kernel 116, as corruption of the guest OS kernel 116 may be undetected and/or the ability of the intrusion monitoring driver 118 to communicate a status of the guest OS kernel 116 may be hindered.

To reduce the risk of failed integrity inspection of the guest OS kernel 116, the OS kernel integrity inspection of the guest OS kernel 116 may be distributed between the intrusion monitoring driver 118 in the first CVM 102 and the integrity scanning application 126 in the second CVM 104. However, because both the first CVM 102 and the second CVM 104 execute within the TEE 106, the private memory 140 and the private memory 142 may be accessible to the first CVM 102 and the second CVM 104. The integrity scanning application 126 may thus be vulnerable to the same risks as the guest OS kernel 116 and/or the intrusion monitoring driver 118. A compromised intrusion monitoring driver 118 may, for example, access private memory 142 and compromise the integrity scanning application 126. Accordingly, reducing the risk of failed integrity inspection of the guest OS kernel 116 may further involve executing the first CVM 102 and the second CVM at different privilege levels, as described in greater detail herein.

In some examples, the processing resource 108 may define privilege levels for CVMs executed in the TEE 106 and may enable or disable different capabilities for a CVM based on its respective privilege level. A CVM executed in the TEE 106 at a more privileged level (a more privileged CVM) may, for example, set access rights to the guest memory 134 for a CVM executed in the TEE 106 at a less privileged level (a less privileged CVM). The less privileged CVM, on the other hand, may be prevented from modifying the access rights set by the more privileged CVM. Examples of setting access rights to the guest memory 134 may include configuring whether a CVM or another entity may access a region of memory, as well as configuring the type of memory access granted (e.g., read-only access, read-write access, or the like).

Executing both the first CVM 102 and the second CVM 104 in the TEE 106 may involve executing the CVMs at different privilege levels. In particular, the processing resource 108 may execute the first CVM 102 in the TEE 106 at a first privilege level and may execute the second CVM 104 in the TEE 106 at a second privilege level, where the second privilege level is more privileged than the first privilege level. In some examples, the second privilege level is the most privileged level of the TEE 106. In executing at a more privileged level, the second CVM 104 may set or modify the access rights to the guest memory 134 for the first CVM 102, while the first CVM 102 may be prevented from modifying these access rights.

In this way, the second CVM 104 may enable access by the second CVM 104 to the private memory 140, thereby granting access by the second CVM 104 (e.g., by the integrity scanning application 126) to the guest OS kernel 116. Moreover, the second CVM 104 may configure access rights for the private memory 142 of the second CVM 104 so that the first CVM 102 is prevented from accessing the integrity scanning application 126 stored therein. The first CVM 102 may thus be prevented from accessing the integrity scanning application 126, as well as from modifying its access rights to the integrity scanning application 126. In this way, risk of a failed OS kernel integrity inspection of the guest OS kernel 116 may be reduced, as the inability of the first CVM 102 to access the private memory 142 may lower the risk that compromise of a component of the first CVM 102 (e.g., the intrusion monitoring driver 118, the guest OS kernel 116, or the like) will also compromise the integrity scanning application 126 of the second CVM 104.

In some examples, in setting access rights to guest memory 134, the second CVM 104 may set a region of guest memory 134 and/or a jump label site to read-only such that any attempt to write to the region and/or the jump label triggers execution of the integrity scanning application 126 (which may involve triggering execution of the second CVM 104). The integrity scanning application 126 may then determine whether to grant access to the region and/or the jump label site. The integrity scanning application 126 may grant access to change a jump label site, for example, if the change is authorized, such as when the change is recorded in a jump label database of the OS binary.

In operation, the integrity scanning application 126 may work with the intrusion monitoring driver 118 to perform OS kernel integrity inspection of (e.g., detect changes to) the guest OS kernel 116. In particular, the intrusion monitoring driver 118 may determine an initial measurement of the guest OS kernel 116, and the integrity scanning application 126 may compare the initial measurement to a current measurement of the guest OS kernel 116 to determine whether the guest OS kernel has been compromised.

The intrusion monitoring driver 118 may measure the guest OS kernel 116 to determine an initial measurement (e.g., a baseline measurement) of the guest OS kernel 116. The initial measurement may be a measurement of one or more regions (e.g., symbols) in the kernel space 112, such as region(s) that should remain static. While the intrusion monitoring driver 118 is illustrated separately from the guest OS kernel 116, in some examples, the intrusion monitoring driver 118 may be included in the guest OS kernel 116 (e.g., as a kernel module). Accordingly, in some examples, the intrusion monitoring driver 118 may monitor (e.g., take measurement(s) of) itself.

In some examples, the initial measurement may be a cryptographic hash digest of the content of the regions in the kernel space 112. The intrusion monitoring driver 112 may determine the initial measurement when the electronic device 100 first boots and transitions to a runtime environment. The intrusion monitoring driver 118 may additionally or alternatively determine the initial measurement for a region near or at the time a corresponding kernel module, kernel code or kernel data is loaded at the region.

In the context used herein, a “hash digest” (which may also be referred to as a “hash,” “a hash value,” “a cryptographic hash,” or “a cryptographic hash value”) is produced by the application of a cryptographic hash function to a value (e.g., an input, such as an image or binary). A “cryptographic hash function” may be a function that is provided through the execution of machine-executable instructions by a processor (e.g., one or multiple CPUs, one or multiple CPU processing cores, and so forth). The cryptographic hash function may be a secure hash function (SHA), any federal information processing standards (FIPS) approved hash function, any national institute of standards and technology (NIST) approved hash function, or any other cryptographic hash function.

The intrusion monitoring driver 118 may communicate the initial measurement to the integrity scanning application 126. The intrusion monitoring driver 118 may, for instance, write the initial measurement to a predetermined (e.g., preconfigured) location, such as inspection information memory location 150. The integrity scanning application 126 may then retrieve the initial measurement from the inspection information memory location 150. The inspection information memory location 150 may be a memory location made available (e.g., accessible) to both the first CVM 102 and the second CVM 104, such as a buffer, shared memory 144, shared memory 146, or the like.

The intrusion monitoring driver 118 may also provide target storage location information to the second CVM 104 at the inspection information memory location 150. The target storage location information may include memory address(es) of the region(s) of the kernel space 112 used to determine the initial measurement. A target memory address of a region to be can include a physical memory address or a virtual memory address. The region(s) identified by the target storage location information may be monitored by the integrity scanning application 126 for OS kernel integrity inspection. The integrity scanning application 126 may, for example, use the target storage location information to determine which region(s) of the guest OS kernel 116 to remeasure to determine whether the guest OS kernel 116 has been modified.

The integrity scanning application 126 may retrieve the initial measurement from the inspection information memory location and may use the target storage location information to determine which region(s) of the guest OS kernel 116 to remeasure. The integrity scanning application 126 may then determine a current measurement of the guest OS kernel 116 by accessing those region(s) and measuring them. As described herein, the second CVM 104, including the integrity scanning application 126 of the second CVM 104, may access the guest OS kernel 116 at the private memory 140 based on the privilege level of the second CVM 104, as well as the second CVM 104 being executed within the TEE 106. Because the second CVM 104 is executed at a more privileged level than the first CVM 102, for example, the second CVM 104 may enable its access to the guest OS kernel 116 in the guest memory 134.

The integrity scanning application 126 may determine whether the guest OS kernel 116 is compromised based on a comparison of the current measurement and an initial measurement of the guest OS kernel 116. That is, for example, the integrity scanning application 126 may determine whether the current measurement and the initial measurement match. A difference between the current measurement and the initial measurement may indicate that the guest OS kernel 116 has been modified, which may indicate that the guest OS kernel 116 has been compromised.

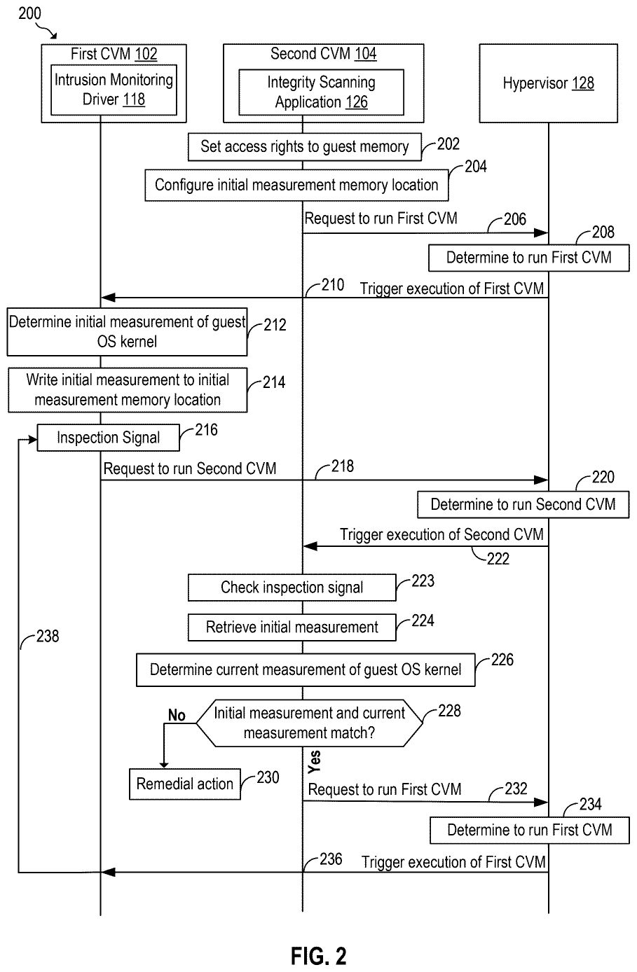

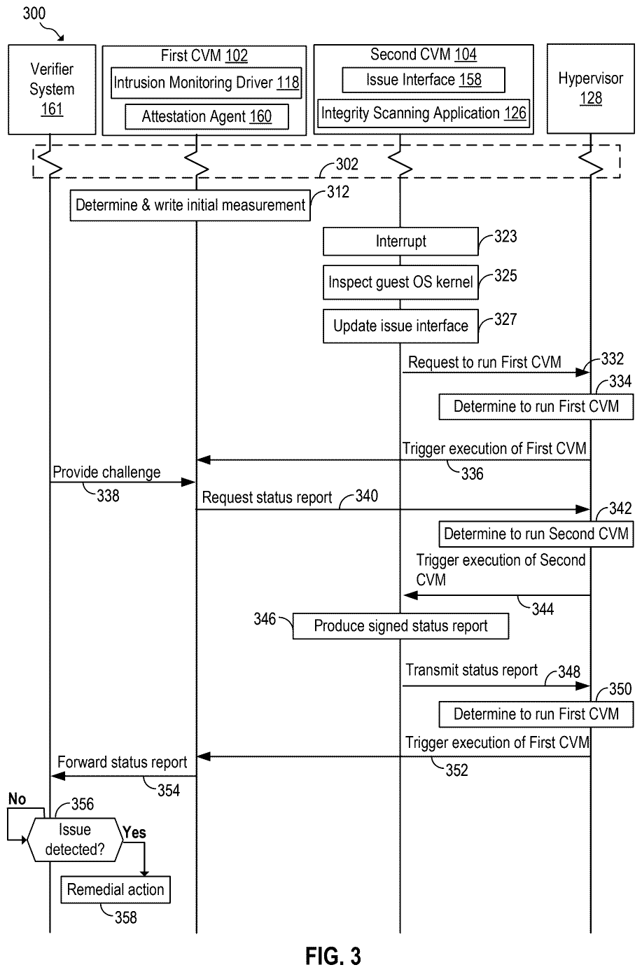

In some examples, the integrity scanning application 126 may determine a current measurement of the guest OS kernel 116 (e.g., by remeasuring the guest OS kernel 116) and compare it to the initial measurement periodically, pursuant to a schedule, responsive to events, or in accordance with other and/or different criteria. As described in greater detail with reference to FIGS. 2-3, the integrity scanning application 126 may retrieve the initial measurement and/or determine the current measurement in response to an inspection signal from the first CVM 102, an interrupt, a challenge from a verifier system, or the like.

In response to determining that the guest OS kernel 116 may be compromised (e.g., in response to determining the current measurement and the initial measurement do not match), the integrity scanning application 126 may take or may initiate a remedial action. As examples, the remedial action may include logging information about the guest OS kernel 116; sending an alert notification to a local or remote operator (e.g., sending a Redfish message to a remote management server); shutting down the electronic device 100; resetting the electronic device 100; taking one or multiple recovery actions (e.g., restoring a kernel image from a golden copy); quiescing cloud operations being performed by the electronic device 100; isolating the electronic device 100 from a cloud computing system; isolating the electronic device 100 from an external network fabric; as well as other and/or different responsive actions. In taking a remedial action, the integrity scanning application 126 may send an alert, via the network 152, reporting an issue to a system administrator.

Processing resources may be used in executing the first CVM 102 and the second CVM 104, as well as in performing the operations for OS kernel integrity inspection by the intrusion monitoring driver 118 and the integrity scanning application 126. In this regard, the hypervisor 128 may present processing resource 108 as one or more virtual processors 154, 156 (e.g., vCPUs) to the first CVM 102 and the second CVM 104. In some examples, the hypervisor 128 may present a set of virtual processing resources to both the first CVM 102 and the second CVM 104. Thus, while virtual processor 154 is illustrated as executing in the first CVM 102 and virtual processor 156 is illustrated as executing in the second CVM 104, both virtual processor 154 and virtual processor 156 may execute in either first CVM 102 or second CVM 104. As described in greater detail herein, sharing virtual processing resources between the first CVM 102 and the second CVM 104 may involve multiplexing between execution of the first CVM 102 and execution of the second CVM 104.

Executing both the first CVM 102 and the second CVM 104 in the TEE 106 may involve multiplexing between execution of the first CVM 102 and execution of the second CVM 104 by the processing resource 108. For instance, to execute the first CVM 102, the processing resource 108 may halt execution of the second CVM 104 and vice versa. In some examples, the hypervisor 128 may manage multiplexing between the first CVM 102 and the second CVM 104. To transition to execution of the second CVM 104, for example, the first CVM 102 may issue a hypercall to the hypervisor 128. The hypervisor 128 may, based on the hypercall, halt execution of the first CVM 102, determine that the second CVM 104 is to be run (e.g., executed), and trigger execution of the second CVM 104. Similarly, to transition to execution of the first CVM 102, the second CVM 104 may issue a hypercall to the hypervisor 128. The hypervisor 128 may, based on this hypercall, halt execution of the second CVM 104, determine that the first CVM 102 is to be run, and trigger execution of the first CVM 102. The first CVM 102 and second CVM may also use hypercalls to communicate information to each other via the hypervisor 128, which may be referred to as an inter-privilege communication mechanism. As described in greater detail with respect to FIGS. 2-3, OS kernel integrity inspection may involve multiplexing between execution of the first CVM 102 and the second CVM 104 to perform operations by the intrusion monitoring driver 118 and the integrity scanning application 126.

Multiplexing between execution of the first CVM 102 and the second CVM 104 may involve sharing a set of virtual processing resources, which may include a collection of virtual processors, between the first CVM 102 and the second CVM 104. As an illustrative example, the first CVM 102 and the second CVM 104 may share the virtual processor 154. Executing the first CVM 102 may involve performing, by the virtual processor 154, a processing operation of the first CVM 102 (e.g., an operation to execute the guest OS 110, an operation performed by the intrusion monitoring driver 118, or the like). To trigger execution of the second CVM 104, the hypervisor 128 may halt execution of the virtual processor 154 in the first CVM 102 and may transition to executing the virtual processor 154 in the second CVM 104. The hypervisor 128 may further issue a hypercall to the second CVM 104, which may be used in transitioning the virtual processor 154 to execute in the second CVM 104 and/or to communicate information between the first CVM 102 and the second CVM 104. Executing the second CVM 104 may then involve performing, by the virtual processor 154, a processing operation of the second CVM 104 (e.g., an operation to execute the SVSM 120, an operation performed by the integrity scanning application 126, or the like). To trigger (e.g., to return to) execution of the first CVM 102, the hypervisor 128 may halt execution of the virtual processor 154 in the second CVM 104 and may transition to executing the virtual processor 154 in the first CVM 102. The hypervisor 128 may further issue a hypercall to the first CVM 102, which may be used in transitioning the virtual processor 154 to execute in the second CVM 104 and/or to communicate information between the first CVM 102 and the second CVM 104. While virtual processor 154 and virtual processor 156 are illustrated as separate resources, virtual processor 154 and virtual processor 156 may represent the same set of resources in some examples.

In some examples, virtual processor 154 and virtual processor 156 may represent separate sets of processing resources. For instance, in some examples, a set of virtual processing resources may be dedicated to performing a processing operation of the second CVM 104 (e.g., an operation performed by the integrity scanning application 126). In such cases, executing the first CVM 102 may involve performing, by the virtual processor 154, the processing operation of the first CVM 102 (e.g., an operation to execute the guest OS 110, an operation performed by the intrusion monitoring driver 118, or the like). To trigger execution of the second CVM 104, the hypervisor 128 may execute the virtual processor 156 in the second CVM 104 to perform a processing operation of the second CVM 104. During the execution of the second virtual processor 156 in the second CVM 104, the virtual processor 154 may continue execution in the first CVM 102. In this way, execution of the second CVM 104 may not disrupt the workload performance of the first CVM 102.

More specifically, in some examples, the virtual processor 156 of the second CVM 104 may implement the integrity scanning application 126. The virtual processor 156 may be a dedicated processing resource for running the integrity scanning application 126. As such, execution of the virtual processor 156 may not disrupt the workload performance, which may be carried out by the virtual processor 154 of the first CVM 102. In other examples, the virtual processor 156 may be a processing resource shared between the first CVM 102 and the second CVM 104. In such cases, execution of the virtual processor 156 may be multiplexed between the first CVM 102 and the second CVM 104.

In some examples, the second CVM 104 may operate on a relatively small (e.g., a reduced) software stack. In this regard, the SVSM 120 may be machine-readable instructions designed to provide security services, such as a virtual trusted platform module (VTPM) (e.g., a virtualized instance of a TPM), to the first CVM 102. Keeping the software stack of the second CVM 104 small may reduce an attack surface (e.g., a vulnerability to compromise) of the second CVM 104, which may contribute to the ability of the SVSM 120 to provide security. Thus, in comparison with the guest OS 110, the SVSM 120 may be a relatively small piece of machine-readable code, and the software stack of the second CVM 104 may be smaller than the software stack of the first CVM 102.

In some examples, to keep the software stack of the second CVM 104 small, the second CVM 104 may lack a networking software stack, such as a transmission control protocol/internet protocol (TCP/IP) stack, for exchanging messages over a network 152. In such cases, the integrity scanning application 126 may not be equipped to send an alert over the network 152 (e.g., to a remote operator). In some examples, however, the first CVM 102 may include a networking software stack and may send an alert over the network 152. In such cases, the integrity scanning application 126 may take a remedial action by communicating that the guest OS kernel 116 has been compromised to the first CVM 102 so that the first CVM 102 may transmit this status over the network 152.

To communicate that the guest OS kernel 116 has been compromised or that the OS kernel integrity inspection has an issue to the first CVM 102, the second CVM 104 may include an issue interface 158. The issue interface 158 may be implemented as a number of platform configuration registers (PCRs) (e.g., a PCR bank). The issue interface 158 may thus securely store values, as a value in a PCR may not be directly overwritten. A PCR value may instead be updated by concatenating data with the current value (e.g., via a hash extension mechanism), which may maintain a history of changes to the value.

In some examples, the issue interface 158 may include a first value, which may indicate whether the guest OS kernel 116 has been compromised. The integrity scanning application 126 may, for example, set the first value to a first setting responsive to determining that the guest OS kernel 116 is compromised.

In some examples, the issue interface 158 may include a second value, which may indicate a delay in operation of the integrity scanning application 126. A delay in operation of the integrity scanning application 126 may be caused by a compromised intrusion monitoring driver 118. In some cases, for example, a compromised intrusion monitoring driver 118 may fail to request to switch execution to the second CVM 104, which may cause a delay in the integrity scanning application 126 operating.

The second value may be a clock, a counter, or the like. For instance, in the case of a clock, the second value may record the delay (e.g., time elapsed) since the integrity scanning application 126 last executed an operation. The delay may indicate compromise of the intrusion monitoring driver 118 when the delay exceeds a threshold (e.g., a predetermined threshold). In the case of a counter, the second value may record the number of times the integrity scanning application 126 has executed an operation. The counter remaining unchanged after a period of time and/or after an event (e.g., after execution of the second CVM 104) may indicate compromise of the intrusion monitoring driver 118. With an uncompromised intrusion monitoring driver 118, on the other hand, the integrity scanning application 126 may write to the issue interface 158 to update the second value (e.g., increment a counter, reset a clock value, or the like).

The first CVM 102 may include an attestation agent 160 (implemented using machine-readable instructions), which may communicate a status report of the guest OS kernel 116 over the network 152 to a verifier system 161. The status report may include the first value and/or the second value from the issue interface 158 and may be obtained by the attestation agent 160 from the second CVM 104. In some examples, the attestation agent 160 may obtain and transmit the status report to the verifier system 161 periodically or according to a schedule.

In some examples, the attestation agent 160 may involve the hypervisor 128 to obtain the status report. In particular, the attestation agent 160 may transmit a hypercall requesting the status report from the integrity scanning application 126 to the hypervisor 128, and, based on the request, the hypervisor 128 may request the status report from the second CVM 104. The second CVM 104 may respond (via a hypercall) with the requested status report to the hypervisor 128, and the hypervisor 128 may forward the requested status report to the attestation agent 160.

In some examples, the status report may be signed by the integrity scanning application 126, which may indicate that the status report has not been faked or tampered with by the attestation agent 160, as may be the case with an attestation agent 160 running in a compromised first CVM 102. Signing the status report may contribute to the security of the status report, as the signature may prove that the status report was provided by the integrity scanning application 126 and not another source. In some examples, the signed status report may be generated using a formal quote process, as described with respect to FIG. 3.

The verifier system 161 may use the status report to determine whether the guest OS kernel 116 has been compromised and/or whether there has been a delay in operation of the integrity scanning application 126 (e.g., whether the intrusion monitoring driver 118 has been compromised). For instance, the verifier system 161 may use the status report to determine whether the first value from the issue interface 158 indicates that the guest OS kernel 116 has been compromised. The verifier system 161 may use the status report to determine whether the second value from the issue interface 158 indicates (e.g., based on the second value being a delay exceeding a threshold, based on the second value being a counter that remaining unchanged, or the like) that the operation of the integrity scanning application 126 has been delayed, which may indicate compromise of the intrusion monitoring driver 118. Responsive to determining that the guest OS kernel 116 has been compromised and/or that there has been a delay in operation of the integrity scanning application 126, the verifier system 161 may generate an alert. The verifier system 161 may additionally or alternatively perform one or more of the remedial actions described herein.

Examples of the verifier system 161 can include any or some combination of the following: a server computer, desktop computer, a notebook computer, a tablet computer, a smartphone, and so forth. The verifier system 161 can be implemented via a processing resource, a machine-readable storage medium (e.g., memory), and/or other components. The verifier system 161 may include machine-readable instructions (software and/or firmware) executable on a hardware processing circuit to perform the operations described herein.

The network 152 can use wired communications, wireless communications, or combinations thereof. Further, the network 152 can include multiple subnetworks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the network 152 can be in the form of a direct network link between devices. Various communications structures and infrastructure can be utilized to implement the network(s).

In some examples, the processing resource 108 may include a single TEE 106. In other examples, the processing resource 108 may include multiple TEEs 106, 162 as shown. In such cases, each TEE may protect entities executing within the TEE from external entities, including entities executing in other TEEs. For instance, the first CVM 102 and the second CVM 104 executing in the TEE 106 may be protected from CVMs or other applications executing in the TEE 162. In this regard, it may be appreciated that additional CVMs and/or applications may be executed in the TEE 162. Moreover, while two TEEs are illustrated, it may be appreciated that the processing resource 108 may execute any number of TEEs. Further, while the first CVM 102 and the second CVM 104 are described herein as executing within the TEE 106, in other examples the processing resource 108 may not execute the first CVM 102 and the second CVM 104 in a TEE. In some examples, for instance, the processing resource 108 may execute the first CVM 102 and the second CVM 104, and the hypervisor 128, or another component of the electronic device 100, may protect the private memory 140 and the private memory 142. The hypervisor 128 may, for example, perform similar techniques to those described as being described by the TEE 106 to make the private memory 140 and the private memory 142 inaccessible to certain entities while keeping access to for the first CVM 102 and the second CVM 104.

While the first CVM 102 and the second CVM 104 are described herein as two CVMs executed within the TEE 106, examples may also be described as executing the first CVM 102 and second CVM 104 as different partitions, privilege levels (e.g., virtual machine privilege levels (VMPLs)), or portions of a single CVM. In this regard, the processing resource 108 may execute the single CVM in the TEE 106, and executing the single CVM may involve executing the first CVM 102 as a first partition of the single CVM and executing the second CVM 104 as a second partition of the single CVM. The single CVM may include virtual resources (e.g., virtual processor(s), virtual memory), which may be used by the first partition and the second partition. In some cases, however, access rights of the first partition and the second partition to these resources may vary as described with respect to the first CVM 102 and the second CVM 104.

A user space (user space 114 and user space 124) may be a memory area where applications and services are executed. As illustrated, for example, the integrity scanning application 126 may be stored and may execute in the user space 124. A kernel space (kernel space 112 and the kernel space 122) may be reserved for storing and executing a guest OS kernel, kernel extensions, and device drivers. As illustrated, for example, the kernel space 112 may include the guest OS kernel 116, as well as an intrusion monitoring driver 118. The SVSM 120 may be stored and may execute in the kernel space 122. The kernel space may be more privileged than the user space and the user space, respectively, and accordingly cannot be accessed by user space processes. Kernel processes, on the other hand, may access both the kernel space and the user space. A kernel space and a user space may alternatively be referred to as protection rings. The processing resource 108 may issue a system call (syscall) to switch from execution of a process in the kernel space to the user space and vice versa.

A “driver” refers to machine-readable instructions that are designated to interact with a specific device, such as a hardware device, an emulated device, or the like. The intrusion monitoring driver 118 and the integrity scanning application 126 may include machine-readable instructions (software and/or firmware) executable on a hardware processing circuit. The intrusion monitoring driver 118 and the integrity scanning application 126 may be implemented with any or some combination of: a microprocessor, a core of a multi-core microprocessor, a microcontroller, a programmable integrated circuit, a programmable gate array, or another hardware processing circuit. Moreover, the intrusion monitoring driver 118 may be executed by the processing resource 108 in executing the first CVM 102, and the integrity scanning application 126 may be executed by the processing resource 108 in executing the second CVM 104.

FIG. 2 is a flow diagram of a process 200 for OS kernel integrity inspection involving an inspection signal, which may be performed by the processing resource 108, according to some examples. As illustrated, the process 200 may be performed by one or more components of the first CVM 102, one or more components of the second CVM 104, and the hypervisor 128, each of which may be executed by the processing resource 108. Process 200 may be implemented in the form of executable instructions stored on a machine-readable storage medium and/or in the form of electronic circuitry.

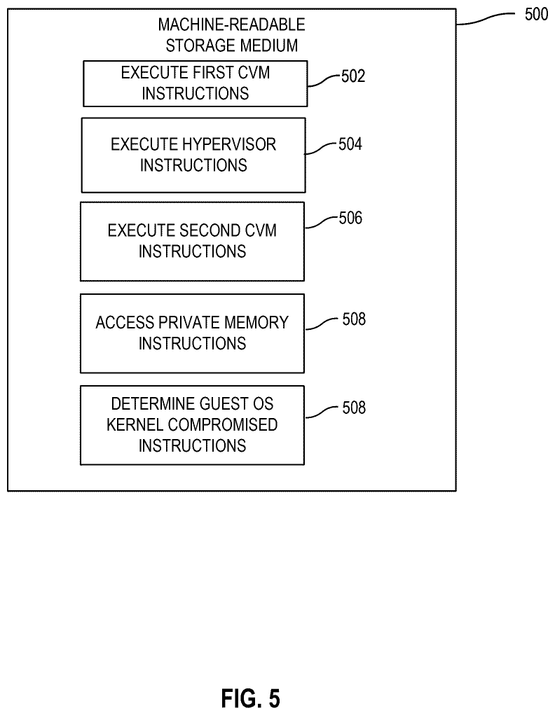

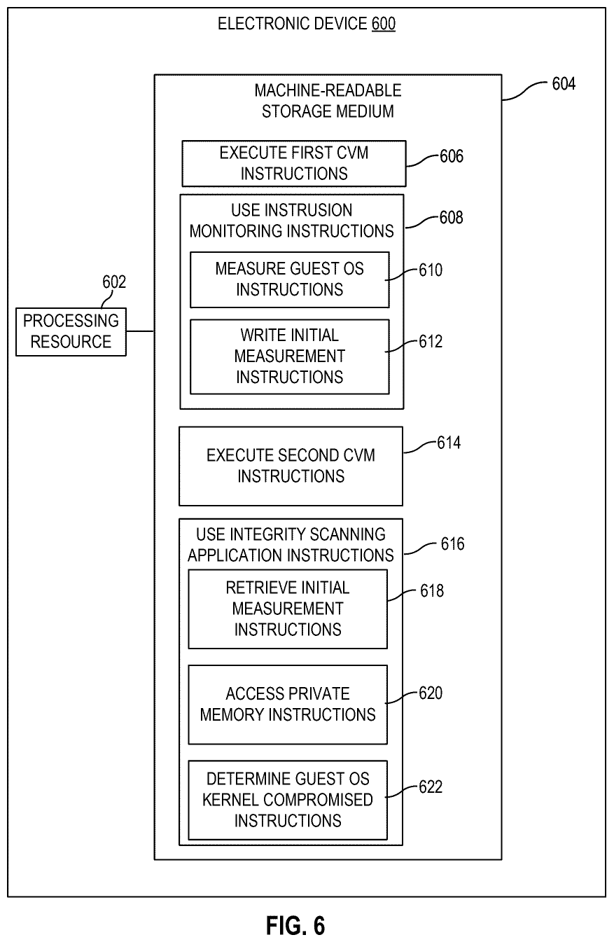

Although FIG. 2 shows tasks performed in a given order, the tasks may be performed in a different order, some tasks may be omitted, and other tasks may be added. Moreover, for illustrative purposes, execution of process 200 is described with reference to processing resource 108 and components executed by processing resource 108. However, other suitable components for execution of process 200 can be utilized (e.g., machine-readable storage medium 500 (FIG. 5), electronic device 600 (FIG. 6)). Additionally, in some examples, the components for executing the process 200 may be spread among multiple devices.

In some examples, the integrity scanning application 126 of the second CVM 104 may (at 202) set access rights to the guest memory 134, including access rights to the private memory 140, where the guest OS kernel 116 is stored, and access rights to the private memory 142, where the integrity scanning application 126 is stored. As described herein, the TEE 106 may make private memory 140 and the private memory 142 inaccessible to external entities. Because the second CVM 104 is executed within the TEE 106 and because the second CVM 104 is more privileged than the first CVM 102, however, the second CVM 104 may access and set access rights to the entire guest memory 134—including both the private memory 140 and the private memory 142. In particular, the second CVM 104 (using the integrity scanning application 126) may grant itself the right to read the private memory 140 so that the second CVM 104 may read the guest OS kernel 116. The second CVM 104 may further make the private memory 142 inaccessible to the first CVM 102 so that the first CVM 102 is unable to modify and/or read the integrity scanning application 126. By setting these access rights, the second CVM 104 may create a separation between the integrity scanning application 126 and the guest OS kernel 116, which may reduce the risk that compromise of the guest OS kernel 116 will also compromise the integrity scanning application 126.

In some examples, in setting access rights to the guest memory 134, the integrity scanning application 126 may set a region of guest memory 134 and/or a jump label site to read-only such that any attempt to write to the region and/or the jump label triggers execution of the integrity scanning application 126 (which may involve triggering execution of the second CVM 104). The integrity scanning application 126 may then determine whether to grant access to the region and/or the jump label site. The integrity scanning application 126 may grant access to change a jump label site, for example, if the change is authorized, such as when the change is recorded in a jump label database of the OS binary.

The integrity scanning application 126 may (at 204) configure the inspection information memory location 150. The inspection information memory location 150 may be a memory location made available (e.g., accessible) to both the first CVM 102 and the second CVM 104, such as a buffer, shared memory 144, shared memory 146, or the like. In some examples, the integrity scanning application 126 may configure the inspection information memory location 150 by enabling access by the first CVM 102 to the inspection information memory location 150. For instance, the integrity scanning application 126 may set access rights to the inspection information memory location 150 so that the first CVM 102 may write an initial measurement to the inspection information memory location 150.

The integrity scanning application 126 may (at 206) send a request to the hypervisor 128. The request may be a request to run the first CVM 102 so that the first CVM 102 can obtain an initial measurement of the guest OS kernel 116. The request may be a hypercall. In some examples, the request may include information to be communicated from the second CVM 104 to the first CVM 102, such as a location of the inspection information memory location 150.

Based on the request, the hypervisor 128 may (at 208) determine to run the first CVM 102. The hypervisor 128 may then trigger (at 210) execution of the first CVM 102. Triggering execution of the first CVM 102 may involve transmitting a hypercall to the first CVM 102. Moreover, switching from execution of the second CVM 104 to the first CVM 102 may involve multiplexing between execution of the second CVM 104 to the first CVM 102. In this regard, in triggering execution of the first CVM 102, the hypervisor 128 may halt execution of the second CVM 104 or may halt one or more virtual processors from executing in the second CVM 104. Multiplexing between execution of the second CVM 104 and first CVM 102 may, for example, involve transitioning one or more virtual processors from executing in the second CVM 104 to the first CVM 102 or vice versa.

The first CVM 102 may (at 212) determine an initial measurement of the guest OS kernel 116 using the intrusion monitoring driver 118. In particular, the intrusion monitoring driver 118 may determine a cryptographic hash digest of the content of one or more regions in the kernel space 112 of the guest OS 110.

The intrusion monitoring driver 118 may (at 214) write the initial measurement to the inspection information memory location 150. The intrusion monitoring driver 118 may write the initial measurement to the inspection information memory location 150 based on the location being communicated to the first CVM 102 by the second CVM 104 (e.g., via hypercalls with the hypervisor 128). For instance, the intrusion monitoring driver 118 may write the initial measurement to a location communicated in the request from the second CVM (at 206) and transmitted to the first CVM 102 by the hypervisor 128 (e.g., at 210).

In some examples, the intrusion monitoring driver 118 may further write target storage location information to the inspection information memory location 150 to communicate this information to the second CVM 104. The target storage location information may identify memory address(es) of the region(s) of the kernel space 112 used to determine the initial measurement.

To trigger inspection of the guest OS kernel 116 by the integrity scanning application 126, the intrusion monitoring driver 118 may (at 216) communicate an inspection signal to the integrity scanning application 126 and may (218) request to run the second CVM 104. The inspection signal may be predetermined (e.g., preconfigured) and may refer to a value or series of values that indicate that the intrusion monitoring driver 118 is requesting the integrity scanning application 126 to inspect the guest OS kernel (e.g., by performing the operations of 223-232). The inspection signal may further indicate that the integrity scanning application 126 has not been compromised.

In some examples, the intrusion monitoring driver 118 may communicate the inspection signal to the second CVM 104 by writing the inspection signal to a predetermined (e.g., preconfigured) memory location made available (e.g., accessible) to both the first CVM 102 and the second CVM 104. For example, the intrusion monitoring driver 118 may further write the inspection signal to the inspection information memory location 150. As such, the inspection information memory location 150 may include a combination of the initial measurement, the target storage location information, and the inspection signal. The intrusion monitoring driver 118 may additionally or alternatively communicate the inspection signal to the second CVM 104 via the hypervisor 128. The intrusion monitoring driver 118 may transmit the inspection signal using a hypercall to the hypervisor 128, for example, and the hypervisor 128 may communicate the inspection signal to the second CVM 104.

The integrity scanning application 126 may check the inspection signal to determine whether to perform OS kernel integrity inspection on the guest OS kernel 116. In some examples, checking the inspection signal may involve checking the value of the inspection signal. For instance, the integrity scanning application 126 may determine whether the inspection signal indicates that inspection is requested or whether the inspection signal is unset or set to an unexpected value.

The intrusion monitoring driver 118 may (at 216) send the inspection signal according to a particular schedule (e.g., a periodic schedule). In some examples, execution of the first CVM 102 may be halted during execution of the second CVM 104. Accordingly, the schedule may be defined based on a period during execution of the first CVM 102. To illustrate, the intrusion monitoring driver 118 may repeatedly send the inspection signal after some period of execution of the first CVM 102 (e.g., every 1 second, 10 seconds, 1 minute, or the like). For instance, after the intrusion monitoring driver 118 sends a first inspection signal, execution of the first CVM 102 may be halted (e.g., to transition to execution of the second CVM 104). Once execution of the first CVM 102 resumes, the intrusion monitoring driver 118 may, according to the schedule, wait some period (e.g., every 1 second, 10 seconds, 1 minute, or the like) before sending a subsequent inspection signal.

The intrusion monitoring driver 118 may (at 218) send a request to the hypervisor 128. The request may be a hypercall. Further, the request may be a request to run the second CVM 104 so that second CVM 104 can remeasure the guest OS kernel 116. That is, for example, the intrusion monitoring driver 118 may request to run the second CVM 104 so that the second CVM may inspect the integrity of the guest OS kernel 116 by inspecting the guest OS kernel 116 for changes. While the actions of the intrusion monitoring driver 118 at 216 and at 218 are illustrated as occurring sequentially, the intrusion monitoring driver 118 may transmit the request (at 216) and the inspection signal (at 218) concurrently. For instance, the request may include the inspection signal in some examples.

Based on the request, the hypervisor 128 may (at 220) determine to run the second CVM 104. The hypervisor 128 may then trigger (at 222) execution of the second CVM 104. Triggering execution of the second CVM 104 may involve transmitting a hypercall to the second CVM 104. Moreover, switching from execution of the first CVM 102 to the second CVM 104 may involve multiplexing between execution of the first CVM 102 to the second CVM 104. In this regard, in triggering execution of the second CVM 104, the hypervisor 128 may halt execution of the first CVM 102 or may halt one or more virtual processors from executing in the first CVM 102. Multiplexing between execution of the first CVM 102 and second CVM 104 may, for example, involve transitioning one or more virtual processors from executing in the first CVM 102 to the second CVM 104 or vice versa.

In some examples, responsive to execution being triggered (at 222), the second CVM 104 may (at 223) check the inspection signal. In some examples, the integrity scanning application 126 may check the inspection signal to determine whether to perform OS kernel integrity inspection on the guest OS kernel 116. Checking the inspection signal may involve reading the value of the inspection signal from the inspection information memory location 150 and checking the value of the inspection signal. Responsive to the inspection signal being set or being set to an expected value, the integrity scanning application 126 may (at 224) retrieve the initial measurement from the inspection information memory location, for example.

Responsive to the inspection signal being unset or set to an unexpected value, on the other hand, the integrity scanning application 126 may refrain from retrieving the initial measurement from the inspection information memory location 150. In some cases, for example, an unset or unexpected value of the inspection signal may indicate that the execution of the second CVM 104 was triggered for a different purpose than performing OS kernel integrity inspection. In such cases, the second CVM 104 may perform other processing operations and/or may request to return to execution of the first CVM 102 (e.g., via a hypercall).

The second CVM 104 may (at 224) retrieve the initial measurement from the inspection information memory location 150 using the integrity scanning application 126. For instance, the integrity scanning application 126 may read the value of the initial measurement from the inspection information memory location 150. As described, the inspection information memory location 150 may further include target storage location information, which the integrity scanning application 126 may also read.

The integrity scanning application 126 may (at 226) determine a current measurement of the guest OS kernel 116. In some examples, the integrity scanning application 126 may determine the current measurement based on accessing the region(s) of the kernel space 112 identified by the target storage information and measuring those regions. In this regard, the second CVM 104 may remeasure the region(s) of the guest OS kernel 116 used in the initial measurement. As described herein, the second CVM 104, including the integrity scanning application 126 executed therein, may access the guest OS kernel 116 based on the access rights set by the second CVM 104 (at 202).

The integrity scanning application 126 may (at 228) compare the initial measurement and the current measurement of the guest OS kernel 116. The integrity scanning application 126 may determine whether the guest OS kernel 116 is compromised based on this comparison. A mismatch between the initial measurement and the current measurement may indicate that the guest OS kernel 116 has been changed, which may indicate that the guest OS kernel is compromised, for example. A match between the initial measurement and the current measurement, on the other hand, may indicate that the guest OS kernel 116 has not been changed, which may indicate that the guest OS kernel is not compromised.

Responsive to a mismatch between the initial measurement and the current measurement, which may indicate that the guest OS kernel has been compromised, the integrity scanning application 126 may (at 230) take a remedial action, such as one or more of the remedial actions described herein. In taking a remedial action, for example, the integrity scanning application 126 may send an alert, via the network 152, which may report an issue to a system administrator. Additionally or alternatively, the integrity scanning application 126 may communicate that the guest OS kernel 116 has been compromised to via the issue interface 158, and the attestation agent 160 may obtain and transmit a status report based on the issue interface 158 over the network 152.

Responsive to a match between the initial measurement and the current measurement, which may indicate that the guest OS kernel has not been compromised, the integrity scanning application 126 may (at 232) transmit a request (e.g., a hypercall) to run the first CVM 102 to the hypervisor 128. In some examples, the integrity scanning application 126 may further reset the value of the inspection signal. The hypervisor 128 may (at 234) determine to run the first CVM 102 based on this request and may (at 236) trigger execution of the first CVM 102.

After execution of the first CVM 102 resumes, the first CVM 102 (e.g., the intrusion monitoring driver 118 of the first CVM 102) may send additional request(s) to run the second CVM 104 based on a schedule, periodically, or in response to an event, such as in response to a kernel module being loaded into the guest OS kernel 116, as indicated by arrow 238. As such, the second CVM 104 may inspect the guest OS kernel 116 (e.g., by repeating the operations of tasks 223-232) regularly.

In some examples, malware may target OS kernel integrity inspection so that changes to the guest OS kernel 116 may go undetected and/or unreported. In targeting OS kernel integrity inspection, malware may, for example, prevent the integrity scanning application 126 from performing the operations of tasks 223-232. For instance, malware may compromise the intrusion monitoring driver 118 to prevent the inspection signal and/or the request to run the second CVM 104 from being sent (at 216 and 218, respectively) so that execution of the second CVM 104 is not triggered (at 222).

In examples where one or more virtual processors continue execution in the first CVM 102 during execution of the second CVM 104, this risk may be counteracted using a heartbeat as the inspection signal sent by the intrusion monitoring driver 118 to the second CVM 104. A “heartbeat” may refer to a value or series of values, such as a sequence of signals, pings, indications, or messages, to represent that the entity (here the intrusion monitoring driver 118) that sends or generates the heartbeat is operating in an acceptable state. The heartbeat may indicate, for example, that the intrusion monitoring driver 118 remains uncompromised. In some examples, the intrusion monitoring driver 118 may send the heartbeat to the second CVM 104 using a hypercall (e.g., via the hypervisor). The intrusion monitoring driver 118 may additionally or alternatively write the heartbeat to a shared memory location accessible by the second CVM 104.

Interruption of the heartbeat (e.g., a missed signal, ping, or indication of the heartbeat) may correspond to the intrusion monitoring driver 118 not operating in an acceptable state. An interruption may indicate, for example, that the intrusion monitoring driver 118 has been compromised, which may stop or prevent the intrusion monitoring driver 118 from running. Responsive to failing to receive a heartbeat signal from the first CVM 102 within a timeout period, which may correspond to an interruption of the heartbeat, the integrity scanning application 126 may treat the guest OS kernel 116 as compromised and may take a remedial action, such as the remedial action(s) discussed at 230.

Sending the heartbeat may involve using one or more virtual processors to execute the intrusion monitoring driver 118 in the first CVM 102 during execution (using one or more additional virtual processors) of the second CVM 104. As an illustrative example, the virtual processor 154 may continue execution in the first CVM 102 while the virtual processor 156, which may be dedicated to running the integrity scanning application 126, executes in the second CVM 104. The virtual processor 154 may execute the intrusion monitoring driver 118 to transmit the heartbeat to the second CVM 104, and the virtual processor 156 may execute the integrity scanning application 126, which may monitor whether the heartbeat signal has been received or interrupted.

In some examples, to counteract the risk that that execution of the second CVM 104 is not triggered (at 222), the integrity scanning application 126 may be executed (to perform the operations of tasks 223-232) in response to a scheduled interrupt, as described with respect to FIG. 3. As further described with respect to FIG. 3, a verifier system 161 may additionally or alternatively check a status report generated based on the issue interface 158 to determine whether OS kernel integrity inspection has been compromised. While use of an inspection signal (FIG. 2) and/or a heartbeat are described separately from use of an interrupt (FIG. 3), and/or verifier system 161 (FIG. 3), examples may include any combination of these techniques.

FIG. 3 is a flow diagram of a process 300 for OS kernel integrity inspection involving an interrupt, according to some examples. As illustrated, the process 300 may be performed by one or more components of the first CVM 102, one or more components of the second CVM 104, and the hypervisor 128, each of which may be executed by the processing resource 108. The process 300 may further be performed by the verifier system 161, which may include a processing resource. Process 300 may be implemented in the form of executable instructions stored on a machine-readable storage medium and/or in the form of electronic circuitry.

For illustrative purposes, execution of process 200 is described with reference to verifier system 161, processing resource 108, and components executed by processing resource 108. However, other suitable components for execution of process 300 can be utilized (e.g., machine-readable storage medium 500 (FIG. 5), electronic device 600 (FIG. 6)). Additionally, in some examples, the components for executing the process 300 may be spread among multiple devices.

Although FIG. 3 shows tasks performed in a given order, the tasks may be performed in a different order, some tasks may be omitted, and other tasks may be added. For instance, in some examples, process 300 may include tasks similar to 202-210 depicted in FIG. 2, which may be performed as described with respect to tasks 202-210. For ease of illustration, these and other task(s) performed prior to 312 are represented by the break line 302.

The intrusion monitoring driver 118 may (at 312) determine an initial measurement of the guest OS kernel 116 and may write the initial measurement to the inspection information memory location 150 (e.g., a predetermined memory location). The task 312 may be similar to and may be performed as described with respect to tasks 212 and 214 (FIG. 2).

An interrupt may (at 323) be triggered at the second CVM 104. In some examples, the second CVM 104 may (using the integrity scanning application 126) schedule the interrupt so that, when triggered, the second CVM 104 may be executed. The interrupt may be scheduled to trigger periodically or according to a schedule. By scheduling the interrupt, the second CVM 104 may schedule the integrity scanning application 126 to inspect the guest OS kernel 116. Moreover, the integrity scanning application 126 may be scheduled to run independent of an inspection signal or heartbeat from the first CVM 102. Because the integrity scanning application 126 may be executed in the absence of a signal (e.g., a request or inspection signal) from the first CVM 102, the integrity scanning application 126 may detect whether the guest OS kernel 116 is compromised even when the intrusion monitoring driver 118 has been compromised. In this regard, the process 300 may mitigate the impact of malware that targets the intrusion monitoring driver 118 in order to prevent a switch to execution of the second CVM 104.

While the interrupt is illustrated and described as being scheduled by and triggered at the second CVM 104, an interrupt may additionally or alternatively be scheduled by and/or triggered at the hypervisor 128 or another component of the electronic device. In some examples, an interrupt may additionally or alternatively be scheduled by and/or triggered at the verifier system 161. The verifier system 161 may, for example, send a message over the network to the first CVM 102 to prompt the first CVM 102 to request to run the second CVM 104. Moreover, switching to the execution of the second CVM 104 in response to the interrupt being triggered (at 323), may involve the use of the hypervisor 128. For instance, the hypervisor 128 may, in response to the interrupt, halt execution of the first CVM 102 and trigger execution of the second CVM 104.

Responsive to the interrupt, the integrity scanning application 126 may (at 325) inspect the guest OS kernel. The task 325 may be similar to and may be performed as described with respect to tasks 224-230 (FIG. 2). For ease of illustration, task 325 is shown as a single task; however, it may be appreciated that task 325 may involve multiple operations. In this regard, in inspecting the guest OS kernel, the integrity scanning application 126 may retrieve the initial measurement from the inspection information memory location 150. The integrity scanning application 126 may further access the private memory to determine a current measurement of the guest OS kernel 116. The integrity scanning application 126 may compare the initial measurement and the current measurement of the guest OS kernel 116. Responsive to a mismatch between the initial measurement and the current measurement, which may indicate that the guest OS kernel has been compromised, the integrity scanning application 126 may take a remedial action, such as one or more of the remedial actions described herein.

The integrity scanning application 126 may (at 327) update the issue interface 158. Responsive to a mismatch between the initial measurement and the current measurement, the integrity scanning application 126 may update a first value of the issue interface 158 to indicate that the guest OS kernel 116 has been compromised. For instance, the integrity scanning application 126 may set the first value to a first setting to indicate that the guest OS kernel 116 has been compromised. In some examples, the integrity scanning application 126 may leave the first value of the issue interface 158 unchanged or may set the first value to a second setting to indicate that the guest OS kernel 116 has not been compromised.

To indicate that task 325 (e.g., one or more operations) was performed by the integrity scanning application 126, the integrity scanning application 126 may (at 327) update a second value of the issue interface 158, which may be a clock, a counter, or the like. In the case of a counter, the integrity scanning application 126 may, for example, increment the counter to indicate that an operation was performed. In the case of a clock, the integrity scanning application 126 may reset the clock value so that the time elapsed since the integrity scanning application 126 last executed an operation is measured from a current point in time. Updating the second value of the issue interface 158 may indicate that the integrity scanning application 126 is not compromised.

The integrity scanning application 126 may (at 332) transmit a request (e.g., a hypercall) to run the first CVM 102 to the hypervisor 128. The hypervisor 128 may (at 334) determine to run the first CVM 102 based on this request and may (at 336) trigger execution of the first CVM 102.

The verifier system 161 may (at 338) provide a challenge to the attestation agent 160 to request a status report. The challenge may be a random unpredictable number generated by the verifier system 161. The verifier system 161 may communicate the challenge to the attestation agent 160 over the network 152.

Responsive to the challenge, the attestation agent 160 may (at 340) request the status report from the integrity scanning application 126. In requesting the status report, the attestation agent 160 may forward the challenge to the integrity scanning application 126. As illustrated, requesting the status report may involve transmitting a hypercall to the hypervisor 128. The hypercall may include the challenge. The hypervisor 128 may (at 342) determine to run the second CVM 104 and may (at 344) trigger execution of the second CVM 104. In triggering execution of the second CVM 104, the hypervisor 128 may transmit a hypercall to the second CVM 104, which may include the challenge and may request the status report.

Responsive to receiving the request from the attestation agent 160 (e.g., via the hypervisor 128), the integrity scanning application 126 may (at 346) produce a signed status report. To produce the signed status report, the integrity scanning application 126 may obtain the contents (e.g., the first value and/or the second value) of the issue interface 158. The integrity scanning application 126 may combine these contents with the challenge and sign the result to produce a signed status report, which may alternatively be referred to as a quote. In some examples, the integrity scanning application 126 may sign the status report with a signature (e.g., a key) known by the second CVM 104 but not the first CVM 102. In this way, the presence of the signature may signal that the status report has come from the integrity scanning application 126 and has not otherwise been faked or tampered with by the attestation agent 160.

The integrity scanning application 126 may (at 348) transmit the signed status report to the attestation agent 160. As illustrated, the integrity scanning application 126 may transmit the signed status report to the attestation agent 160 via a hypercall to the hypervisor 128. The hypervisor 128 may (at 350) determine to run the first CVM 102 and may (at 352) trigger execution of the first CVM 102. In triggering execution of the first CVM 102, the hypervisor 128 may transmit a hypercall to the first CVM 102, which may include the signed status report.

Responsive to receiving the signed status report, the attestation agent 160 may (at 354) forward the signed status report to the verifier system 161. The attestation agent 160 may forward the signed status report to the verifier system 161 via the network 152.

The verifier system 161 may (at 356) determine whether an issue has been detected based on the status report. The issue may include the compromise of the guest OS kernel 116, the compromise of the intrusion monitoring driver 118, or the like. In some examples, the verifier system 161 may use the first value included in the status report from the issue interface 158 to determine whether the guest OS kernel 116 has been compromised. As described herein, for example, the integrity scanning application 126 may (at 327) update the first value of the issue interface 158 to indicate that the guest OS kernel 116 has been compromised as a remedial action.

The verifier system 161 may use the second value in the status report from the issue interface 158 to determine a delay in operation of the integrity scanning application 126, which may indicate that the intrusion monitoring driver 118 has been compromised. Because integrity scanning application 126 should update the second value (at 327) in the case of an uncompromised intrusion monitoring driver 118, the failure of the integrity scanning application 126 to update the second value may indicate that the intrusion monitoring driver 118 has been compromised. In the case that the second value is a clock value, the verifier system 161 may detect this failure based on the second value exceeding a threshold. In the case that the second value is a counter value, verifier system 161 may detect this failure based on the second value remaining unchanged after a period of time and/or after an event (e.g., after execution of the second CVM 104).

In some examples, the verifier system 161 may further detect an issue based on the status report not being signed and/or based on the status report lacking the challenge, each of which may indicate compromise of the first CVM 102 (e.g., compromise of the guest OS kernel 116, the intrusion monitoring driver 118, the attestation agent 160, or the like). In some examples, the verifier system 161 may detect an issue based on failing to receive the status report within a certain period of time, which may indicate compromise of the first CVM 102.

In response to the detecting an issue, the verifier system 161 may (at 358) take a remedial action. In some examples, the verifier system 161 may generate and/or transmit an alert for the remedial action. In some examples, when the second value of the issue interface 158 is a counter that has gone unchanged or a clock value that has exceeded a threshold, which may indicate that execution of the second CVM 104 failed to be triggered, the verifier system 161 may take a remedial action by requesting to run the second CVM 104. The verifier system 161 may make such a request via a request to the first CVM 102 over the network 152, for example. The remedial action may additionally or alternatively involve any other remedial actions described herein.

In some examples, the verifier system 161 may provide a challenge to request a status report (at 338) periodically, pursuant to a schedule, responsive to an event, or in accordance with other and/or different criteria. For instance, the verifier system 161 may repeatedly provide the challenge after a period of time has elapsed. Further, while the integrity scanning application 126 is shown as performing tasks 325-327 prior to the verifier system 161 providing the challenge (at 338), in some examples, the integrity scanning application 126 may perform tasks 325-327 responsive to the challenge. In this regard, in response to receiving the request for a status report from the attestation agent, the integrity scanning application 126 may inspect the guest OS kernel, may update the issue interface, and may produce and transmit the signed status report. In this regard, the challenge from the verifier system 161 may be used in addition to or as an alternative to an interrupt.

While process 200 (FIG. 2) and process 300 are illustrated and described separately, operations of process 200 may be performed in process 300 and vice versa. In this regard, the verifier system 161 may detect issues (e.g., as described at 356) in combination with use of an inspection signal, such as the inspection signal described at 218 (FIG. 2). Moreover, integrity scanning application 126 may update issue interface 158 after performing operations in response to execution associated with the inspection signal.

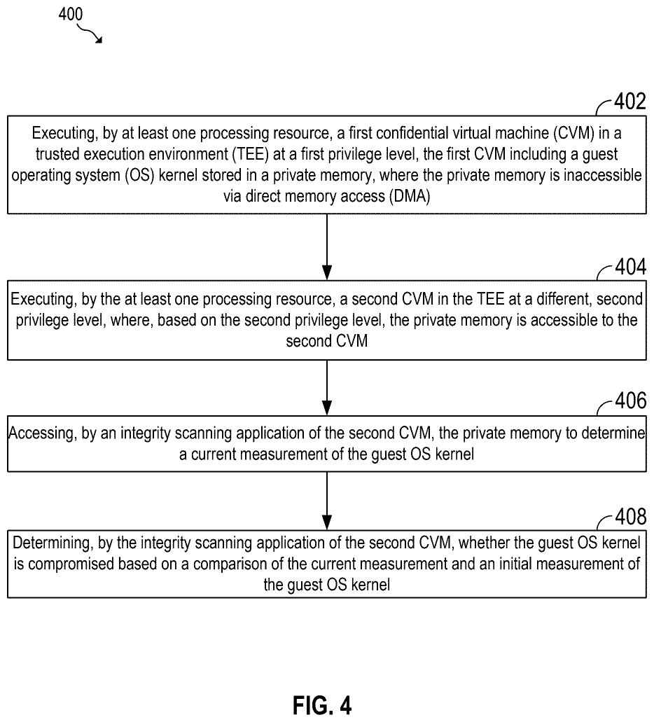

FIG. 4 is a flow diagram of a process 400 for performing OS kernel integrity inspection using a first CVM and a second CVM executed in a TEE, according to some examples. Although FIG. 4 shows tasks performed in a given order, the tasks may be performed in a different order, some tasks may be omitted, and other tasks may be added.

The process 400 includes executing (at 402), by at least one processing resource (e.g., 108 in FIG. 1), a first CVM in a TEE at a first privilege level. The first CVM may include a guest OS kernel stored in a private memory, and the private memory may be inaccessible via direct memory access. The private memory may be protected by the TEE, for example.

The process 400 includes executing (at 404), by the at least one processing resource, a second CVM in the TEE at a different, second privilege level. Based on the second privilege level, the private memory may be accessible to the second CVM. The second privilege level may be more privileged than the first privilege level. Accordingly, the second CVM may control a guest memory that includes the private memory, and the second CVM may set access rights to the guest memory. The second CVM may, for example, enable its access to the private memory, while limiting the access of the first CVM to an additional private memory, where a portion of the second CVM may be stored. In some examples, an integrity scanning application of the second CVM may be stored in the additional private memory.

In some examples, the process 400 may involve executing, by the at least one processing resource, a hypervisor (e.g., 128 in FIG. 1). The hypervisor may manage physical resources, such as processing resources, to control execution of the first CVM and the second CVM, for example. In this regard, the process 400 may further involve triggering, by the hypervisor, execution of the second CVM responsive to a hypercall from the first CVM.

The process 400 includes accessing (at 406), by an integrity scanning application (e.g., 126 in FIG. 1) of the second CVM, the private memory to determine a current measurement of the guest OS kernel. Based on the access rights set by the second CVM to the private memory, for example, the integrity scanning application may access the private memory. The integrity scanning application may further measure one or more regions of the guest OS kernel, which may be region(s) used to determine an initial measurement of the guest OS kernel, for the current measurement.

In some examples, the integrity scanning application of the second CVM may access the private memory responsive to the execution of the second CVM triggered by the hypervisor. In some examples, the integrity scanning application of the second CVM may access the private memory responsive to receiving an inspection signal from the first CVM and/or responsive to an interrupt scheduled by the second CVM.

The process 400 includes determining (at 408), by the integrity scanning application of the second CVM, whether the guest OS kernel is compromised based on a comparison of the current measurement and an initial measurement of the guest OS kernel. In comparing the measurements, a mismatch between the current measurement and the initial measurement may indicate that the guest OS kernel has been modified, which may indicate that the guest OS kernel is compromised. A match between the current measurement and the initial measurement, on the other hand, may indicate that the guest OS kernel is not compromised. Responsive to a compromised guest OS kernel, the integrity scanning application may take a remedial action.

In some examples, the process 400 may involve sharing a set of virtual resources between the first CVM and the second CVM. Sharing the set of virtual resources may involve multiplexing, by the at least one processing resource, between execution of the first CVM and execution of the second CVM in the TEE. For instance, the process 400 may involve executing, by the at least one processing resource, a virtual processor in the first CVM. Responsive to the hypervisor triggering the execution of the second CVM, the at least one processing resource may halt execution of the virtual processor in the first CVM and may execute the virtual processor in the second CVM. In some examples, the process 400 may involve executing, by the at least one processing resource, a first virtual processor in the first CVM. Responsive to the hypervisor triggering the execution of the second CVM, the at least one processing resource may continue execution of the first virtual processor in the first CVM and may execute a different, second virtual processor in the second CVM.

In some examples, the process 400 may involve measuring, by an intrusion monitoring driver of the first CVM, the guest OS kernel to determine the initial measurement. The process may further involve writing, by the intrusion monitoring driver of the first CVM, the initial measurement to a memory location communicated to the first CVM by the second CVM, and the process 400 may involve transmitting, by an intrusion monitoring driver of the first CVM, the hypercall to the hypervisor based on writing the initial measurement to the memory location.

In some examples, the process 400 may involve receiving, by an attestation agent (e.g., 160 in FIG. 1) of the first CVM, a challenge from a verifier system (e.g., 161 in FIG. 1). The attestation agent may transmit a request for a status report from the integrity scanning application of the second CVM based on the challenge. The attestation agent may further forward a signed status report received from the integrity scanning application of the second CVM to the verifier system. In some examples, the process 400 may involve, responsive to determining the guest OS kernel is compromised, updating, by the integrity scanning application of the second CVM, an issue interface (e.g., 158 in FIG. 1). The integrity scanning application may further, responsive to receiving the request for the status report, produce the signed status report based on the issue interface, the challenge, and a signature.

FIG. 5 is a block diagram of a machine-readable storage medium 500 having instructions for performing OS kernel integrity inspection using a first CVM and a second CVM executed in a TEE, according to some examples. The machine-readable storage medium 500 includes instructions 502, 504, 506, 508, and 510 (hereinafter collectively referred to as instructions 502-510). Further, memory 132 (FIG. 1) may be an example of machine-readable storage medium 500, and processing resource 108 (FIG. 1) may execute the instructions 502-510.

The execute first CVM instructions 502 may be executable by at least one processing resource (e.g., 108 in FIG. 1) to execute a first CVM in a TEE at a first privilege level. The first CVM may include a guest operating system (OS) kernel stored in a private memory, and the private memory may be inaccessible via direct memory access. The private memory may be protected by the TEE (e.g., 106 in FIG. 1), for example.

The execute hypervisor instructions 504 may be executable by the at least one processing resource to execute a hypervisor outside the TEE. The hypervisor may, responsive to receipt of a hypercall from the first CVM, trigger execution of a second CVM. The hypervisor (e.g., 106 in FIG. 1) may manage physical resources, such as processing resources, to control execution of the first CVM and the second CVM, for example.

The execute second CVM instructions 506 may be executable by the at least one processing resource to execute the second CVM in the TEE at a different, second privilege level. Based on the second privilege level, the private memory may be accessible to the second CVM. The second privilege level may be more privileged than the first privilege level.

The access private memory instructions 508 may be executable by the at least one processing resource to access, using an integrity scanning application of the second CVM, the private memory to determine a current measurement of the guest OS kernel.

The determine guest OS kernel compromised instructions 510 may be executable by the at least one processing resource to determine, using the integrity scanning application of the second CVM, whether the guest OS kernel is compromised based on a comparison of the current measurement and an initial measurement of the guest OS kernel.

In some examples, based on the TEE, the private memory is further inaccessible to the hypervisor. In some examples, the machine-readable storage medium 500 includes instructions executable to, responsive to determining that the guest OS kernel is not compromised, transmit, using the integrity scanning application of the second CVM, an additional hypercall to the hypervisor. These instructions may be further executable to, responsive to receipt of the additional hypercall, trigger, using the hypervisor, execution of the first CVM. In some examples, the machine-readable storage medium 500 includes instructions executable to, prior to execution of the first CVM: set, using the second CVM, access rights to the private memory; and transmit, using the second CVM, an additional hypercall to the hypervisor. These instructions may be further executable to, responsive to receipt of the additional hypercall, trigger, using the hypervisor, the execution of the first CVM.

As described in detail herein, machine-readable storage medium 500 may be encoded with a series of executable instructions, including instructions 502-510. Machine-readable storage medium 500 may be encoded with executable instructions to perform the operations of the process 200 described in FIG. 2, the process 300 described in FIG. 3, the process 400 described in FIG. 4, and/or any other operations performed by a component of the electronic device 100 (FIG. 1), without limiting the scope of the present disclosure.

FIG. 6 is a block diagram of an electronic device 600 capable of performing OS kernel integrity inspection using a first CVM and a second CVM executed in a TEE, according to some examples. The electronic device 600 includes a processing resource 602 and a machine-readable storage medium 604 including instructions 606, 608, 610, 612, 614, 616, 618, 620, and 622 (hereinafter collectively referred to as instructions 606-622) for performing OS kernel integrity inspection using a first CVM and a second CVM executed in a TEE. The electronic device 600 may be, for example, a server, client computer, notebook computer, a slate computing device, a portable reading device, a wireless email device, a mobile phone, or any other computing device. Further, electronic device 600 may be an example of electronic device 100 (FIG. 1).

The execute first CVM instructions 606 may be executable to execute a first CVM in a TEE at a first privilege level. The first CVM may include a guest OS kernel stored in a private memory, and the private memory may be inaccessible via direct memory access. In some examples, an intrusion monitoring driver (e.g., 118 in FIG. 1) of the first CVM is also stored in the private memory. For instance, the intrusion monitoring driver may be included in the guest OS kernel, in some examples.

The use intrusion monitoring instructions 608 may include the measure guest OS instructions 610 and the write initial measurement instructions 612. The measure guest OS instructions 610 may be executable to use an intrusion monitoring driver of the first CVM to measure the guest OS kernel to determine an initial measurement. The initial measurement may be a cryptographic hash digest of the content of one or more regions of the guest OS kernel. The write initial measurement instructions 612 may be executable to use an intrusion monitoring driver of the first CVM to write the initial measurement to a predetermined memory location, such as the inspection information memory location 150 (FIG. 1). The intrusion monitoring driver may further write target storage information, which may identify the one or more regions measured for the initial measurement, to the predetermined memory location. In some examples, the machine-readable storage medium 604 may further include instructions to communicate, using the second CVM, the predetermined memory location to the first CVM. The second CVM may, for example, communicate the predetermined memory location using a hypercall.

The execute second CVM instructions 614 may be executable to execute a second CVM in the TEE at a different, second privilege level. Based on the second privilege level, the private memory may be accessible to the second CVM. In some examples, the second CVM may include a SVSM (e.g., 120 in FIG. 1).

The use integrity scanning application instructions 616 may include the retrieve initial measurement instructions 618, the access private memory instructions 620, and the determine guest OS kernel compromised instructions 622. The retrieve initial measurement instructions 618 may be executable to use an integrity scanning application of the second CVM to retrieve the initial measurement from the predetermined memory location. The integrity scanning application may also retrieve target storage information to determine which region(s) of the guest OS kernel to measure. The access private memory instructions 620 may be executable to use an integrity scanning application of the second CVM to access the private memory to determine a current measurement of the guest OS kernel. The integrity scanning application may access and measure the region(s) of the guest OS kernel identified in the target storage information for the current measurement. The determine guest OS kernel compromised instructions 622 may be executable to use an integrity scanning application of the second CVM to determine whether the guest OS kernel is compromised based on a comparison of the current measurement and the initial measurement.

Processing resource 602 can include a collection of hardware processors. A hardware processor can include a microprocessor, a core of a multi-core microprocessor, a microcontroller, a programmable integrated circuit, a programmable gate array, or another hardware processing circuit. Processing resource 602 may be an example of processing resource 108 (FIG. 1). Processing resource 602 may fetch, decode, and execute instructions 606-622 to perform OS kernel integrity inspection using a first CVM and a second CVM executed in a TEE. As an alternative or in addition to retrieving and executing instructions, processing resource 602 may include at least one integrated circuit (IC), other control logic, other electronic circuits, or combinations thereof that include a number of electronic components for performing the functionality of instructions 606-622.

As described in detail herein, machine-readable storage medium 604 may be encoded with a series of executable instructions, including instructions 606-622. Machine-readable storage medium 604 may be encoded with executable instructions to perform the operations of the process 200 described in FIG. 2, the process 300 described in FIG. 3, the process 400 described in FIG. 4, the instructions 502-510 described in FIG. 5, and/or any other operations performed by a component of the electronic device 100 (FIG. 1), without limiting the scope of the present disclosure.

A storage medium (e.g., 500 in FIG. 5 or 604 in FIG. 6) in which machine-readable instructions are stored can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. As such, the machine-readable storage medium 500 (FIG. 5) and the machine-readable storage medium 604 (FIG. 6) can be non-transitory. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the terms “includes,” “including,” “comprises,” “comprising,” “have,” or “having” when used in this disclosure specify the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method, comprising:
executing, by at least one processing resource, a first confidential virtual machine (CVM) in a trusted execution environment (TEE) at a first privilege level, the first CVM comprising a guest operating system (OS) kernel stored in a private memory, wherein the private memory is inaccessible via direct memory access;
executing, by the at least one processing resource, a second CVM in the TEE at a different, second privilege level, wherein, based on the second privilege level, the private memory is accessible to the second CVM;
accessing, by an integrity scanning application of the second CVM, the private memory to determine a current measurement of the guest OS kernel; and
determining, by the integrity scanning application of the second CVM, whether the guest OS kernel is compromised based on a comparison of the current measurement and an initial measurement of the guest OS kernel.

2. The method of claim 1, further comprising:
sharing a set of virtual resources between the first CVM and the second CVM by multiplexing, by the at least one processing resource, between execution of the first CVM and execution of the second CVM in the TEE.

3. The method of claim 1, wherein the integrity scanning application of the second CVM is stored in an additional private memory, and wherein, based on the first privilege level, the additional private memory is inaccessible to the first CVM.

4. The method of claim 1, further comprising:
executing, by the at least one processing resource, a hypervisor;
triggering, by the hypervisor, execution of the second CVM responsive to a hypercall from the first CVM.

5. The method of claim 4, further comprising:
accessing, by the integrity scanning application of the second CVM, the private memory to determine the current measurement responsive to the execution of the second CVM triggered by the hypervisor.

6. The method of claim 4, further comprising:
measuring, by an intrusion monitoring driver of the first CVM, the guest OS kernel to determine the initial measurement;
writing, by the intrusion monitoring driver of the first CVM, the initial measurement to a memory location communicated to the first CVM by the second CVM; and
transmitting, by an intrusion monitoring driver of the first CVM, the hypercall to the hypervisor based on writing the initial measurement to the memory location.

7. The method of claim 4, further comprising:
executing, by the at least one processing resource, a virtual processor in the first CVM; and
responsive to the hypervisor triggering the execution of the second CVM:
halting, by the at least one processing resource, execution of the virtual processor in the first CVM; and
executing, by the at least one processing resource, the virtual processor in the second CVM.

8. The method of claim 4, further comprising:
executing, by the at least one processing resource, a first virtual processor in the first CVM; and
responsive to the hypervisor triggering the execution of the second CVM:
continuing, by the at least one processing resource, execution of the first virtual processor in the first CVM; and
executing, by the at least one processing resource, a different, second virtual processor in the second CVM.

9. The method of claim 1, further comprising:
accessing, by the integrity scanning application of the second CVM, the private memory to determine the current measurement responsive to an inspection signal from the first CVM.

10. The method of claim 1, further comprising:
accessing, by the integrity scanning application of the second CVM, the private memory to determine the current measurement responsive to an interrupt scheduled by the second CVM.

11. The method of claim 1, further comprising:
receiving, by an attestation agent of the first CVM, a challenge from a verifier system;
transmitting, by the attestation agent of the first CVM, a request for a status report from the integrity scanning application of the second CVM based on the challenge; and
forwarding, by the attestation agent of the first CVM, a signed status report received from the integrity scanning application of the second CVM to the verifier system.

12. The method of claim 11, further comprising:
responsive to determining the guest OS kernel is compromised, updating, by the integrity scanning application of the second CVM, an issue interface; and
responsive to receiving the request for the status report, producing, by the integrity scanning application of the second CVM, the signed status report based on the issue interface, the challenge, and a signature.

13. A non-transitory machine-readable storage medium comprising instructions executable by at least one processing resource of a computing device to:
execute a first confidential virtual machine (CVM) in a trusted execution environment (TEE) at a first privilege level, the first CVM comprising a guest operating system (OS) kernel stored in a private memory, wherein the private memory is inaccessible via direct memory access;
execute a hypervisor outside the TEE, the hypervisor to, responsive to receipt of a hypercall from the first CVM, trigger execution of a second CVM;
execute the second CVM in the TEE at a different, second privilege level, wherein, based on the second privilege level, the private memory is accessible to the second CVM;
access, using an integrity scanning application of the second CVM, the private memory to determine a current measurement of the guest OS kernel; and
determine, using the integrity scanning application of the second CVM, whether the guest OS kernel is compromised based on a comparison of the current measurement and an initial measurement of the guest OS kernel.

14. The non-transitory machine-readable storage medium of claim 13, wherein, based on the TEE, the private memory is further inaccessible to the hypervisor.

15. The non-transitory machine-readable storage medium of claim 13, wherein the instructions are further executable to:
responsive to determining that the guest OS kernel is not compromised, transmit, using the integrity scanning application of the second CVM, an additional hypercall to the hypervisor; and
responsive to receipt of the additional hypercall, trigger, using the hypervisor, execution of the first CVM.

16. The non-transitory machine-readable storage medium of claim 13, wherein the instructions are further executable to:
prior to execution of the first CVM:
set, using the second CVM, access rights to the private memory; and
transmit, using the second CVM, an additional hypercall to the hypervisor; and
responsive to receipt of the additional hypercall, trigger, using the hypervisor, the execution of the first CVM.

17. A system comprising:
at least one processing resource; and
a non-transitory machine-readable storage medium comprising instructions executable by the at least one processing resource to:
execute a first confidential virtual machine (CVM) in a trusted execution environment (TEE) at a first privilege level, the first CVM comprising a guest operating system (OS) kernel stored in a private memory, wherein the private memory is inaccessible via direct memory access;
using an intrusion monitoring driver of the first CVM:
measure the guest OS kernel to determine an initial measurement; and
write the initial measurement to a predetermined memory location;
execute a second CVM in the TEE at a different, second privilege level, wherein, based on the second privilege level, the private memory is accessible to the second CVM;
using an integrity scanning application of the second CVM:
retrieve the initial measurement from the predetermined memory location;
access the private memory to determine a current measurement of the guest OS kernel; and
determine whether the guest OS kernel is compromised based on a comparison of the current measurement and the initial measurement.

18. The system of claim 17, wherein the instructions are further executable to:
communicate, using the second CVM, the predetermined memory location to the first CVM.

19. The system of claim 17, wherein the intrusion monitoring driver is stored in the private memory.

20. The system of claim 17, wherein the second CVM comprises a secure virtual machine service module.
